(19) United States
(12) Patent Application Publication
(10) Pub. No.: US 2007/0109135 A1
(43) Pub. Date: May 17, 2007

(54) Transmitter loop monitor

(75) Inventor: Frederic Peterson, Chelmsford, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: DOGWATCH INC.

(21) Appl. No.: 11/591,266

(22) Filed: Nov. 1, 2006

Related U.S. Application Data
(60) Provisional application No. 60/732,980, filed on Nov. 3, 2005.

(51) Int. Cl. G08B 23/00

(52) U.S. Cl. 340/573.3; 340/407.1

(57) ABSTRACT

A device for monitoring the integrity of an antenna wire loop, such as for a pet containment system, and a system using the monitoring device are disclosed. The device can be incorporated in the transmitter portion of the pet containment system or can be a stand-alone device electrically and operationally coupled thereto. The device includes a current monitoring portion that monitors the current driven in the antenna wire loop and a display portion that displays the intensity of the electromagnetic field in appropriate units, such as feet.

### CROSS REFERENCE TO RELATED APPLICATIONS

This application claims the benefit of U.S. provisional patent application No. 60/732,980 filed on Nov. 3, 2005, which is incorporated herein in its entirety by reference.

### STATEMENT REGARDING FEDERALLY SPONSORED RESEARCH OR DEVELOPMENT

(Not applicable)

### BACKGROUND OF THE INVENTION

This invention relates to a transmitter for a pet containment system and, more particularly, to a transmitter having an antenna wire-loop monitor for monitoring and visually displaying an indication of the status of a boundary signal provided by the antenna wire loop.

Pet containment systems are used to confine domesticated pets, such as dogs or other animals, within a pre-defined area or, alternatively, to keep pets outside of a pre-defined area. Typical containment systems include an antenna wire, an electrical power source, a transmitter, and a receiver.

The antenna wire is buried in a desired pattern or arrangement, usually a closed loop, to define the perimeter or boundary of an area across which one's pet is conditioned not to cross. The transmitter and electrical power source are electrically-coupled to the buried antenna wire. More particularly, the electrical power source provides current to the transmitter and the transmitter drives current through the antenna wire, causing the antenna wire to radiate or induce an electromagnetic field.

Referring to FIG. 3, a buried antenna wire 15 for a pet containment system is shown. The antenna wire 15 is buried at a relatively shallow depth, D, and further, connected to a power source (not shown). Current is driven through the antenna wire 15, causing a three-dimensional electromagnetic field 40 to radiate 360 degrees about the antenna wire 15. The “signal field” 42 corresponds to the two-dimensional extent of the electromagnetic field on either side of the antenna wire 15.

Within the “signal field” 42 there is a first (audible signal) zone A and a second (electrical stimulation) zone B. The second zone B corresponds to the area to either side of the projection of the antenna wire 15 at the ground surface 45 in which a pet wearing a receiver will experience electrical stimulation if the pet enters the second zone B. In FIG. 3, the second zone B extends for a distance d_{B} in both directions orthogonal to the projection of the antenna wire 15 at the ground surface 45. The lineal extent of the second zone B corresponds to a point 49 at which, for a pre-determined current of magnitude I_{B}, the strength of the electromagnetic field is sufficient to cause the receiver to apply an electrical stimulation to the pet wearing the receiver.

The first zone A extends beyond the second zone B for an additional distance d_{A} in both directions orthogonal to the projection of the antenna wire 15 at the ground surface 45. The lineal extend of the first zone A is defined by the area between point 49 and point 48 at which, for a pre-determined current of magnitude I_{A}, the strength of the electromagnetic field is sufficient to cause the receiver to provide an audible warning signal but not sufficient to cause the receiver to apply an electrical stimulation.

Thus the receiver attached to an animal collar is structured and arranged to detect the electromagnetic field and, moreover, to differentiate between zone A and zone B field strengths. Thus, depending on the intensity of transmission of the electromagnetic field, the depth of burial, and the proximate distance between the receiver and the buried antenna wire 15, the pet hears an audible warning signal or receives an appropriate stimulus when he or she enters either zone A or zone B, respectively.

For example, one well-known pet containment system is the Hidden Fence System manufactured by DogWatch®, Inc. of Natick, Mass. In the Hidden Fence System, the transmitter controls the transmission intensity of antenna wire so that the receiver detects the electromagnetic field at various, predetermined distances from the antenna wire. Typically, in the first zone A of detection, the receiver senses a relatively weak electromagnetic field and provides an audible warning, such as a chirping or ticking noise, to the animal wearing the receiver. In the second zone B, which is closer to the antenna wire 15, the receiver senses a stronger electromagnetic field, causing an electrical stimulus to be applied to the animal through the receiver as an indication to the animal that it is too close to the perimeter. Through appropriate training and conditioned response, the animal learns to stay away from the perimeter to avoid both the audible warning and the electrical stimulus.

From time to time, the closed-loop antenna wire 15 is subject to interruption from natural causes, such as from rain, age or burrowing rodents, or from artificial causes, such as from a garden implement or lawn tool. Interruptions due to artificial causes, typically, result in an immediate open circuit of the antenna wire 15 loop at a discrete location. Conventionally, interruptions or open circuits cause the transmitter to emit an audible and/or visual signal to alert the user of the open circuit condition. Such interruptions and their location in the antenna wire 15 loop, thus, are immediately known and can be quickly corrected.

However, interruptions due to natural causes or a combination of natural and artificial causes, which can occur over a relatively long period of time or are unseen, are less easily known or corrected. Indeed, when a break in the buried antenna wire 15 loop occurs due to natural causes, the location of the break is uncertain. As a result, it may be necessary to excavate the entire antenna wire 15 loop, to locate the break.

Therefore, it would be desirable to provide a pet containment system that includes a loop monitoring system or device that is capable of detecting the current flow through the antenna wire 15 and displaying the results of the same so that the problem area can be located before the problem area becomes a break in the antenna wire 15 loop, at which point the problem area cannot be located without excavating the antenna wire 15.

### BRIEF SUMMARY OF THE INVENTION

A device for monitoring the integrity of an antenna wire loop, such as for a pet containment system, and a system using the monitoring device are disclosed. The device can be incorporated in the transmitter portion of the pet containment system or can be a stand-alone device electrically and operationally coupled thereto. The device includes a current monitoring portion to monitor the current in the antenna wire loop and a display portion to display the intensity of the electromagnetic field.

### BRIEF DESCRIPTION OF THE SEVERAL VIEWS OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a monitoring portion and display portion according to the device of the present invention;

FIG. 2 is a circuit diagram of a containment system according to the present invention; and

FIG. 3 is a diagram of a buried antenna wire and the electromagnetic field generated thereby.

### DETAILED DESCRIPTION OF THE INVENTION

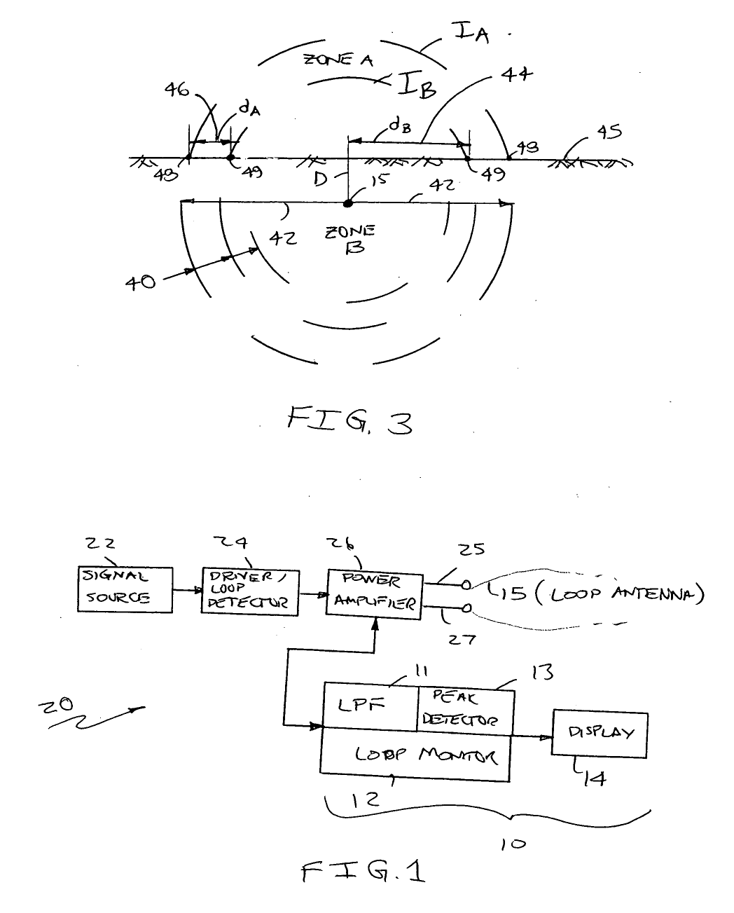

A device for monitoring and visually displaying the intensity of an electromagnetic field generated by an antenna wire, such as a buried antenna wire for a pet containment system, is disclosed. Referring to FIG. 1, the device 10 includes a current or loop monitor 12 and a display portion 14. The loop monitor 12 provides an indirect measure of the intensity of the electromagnetic signal being radiated by the antenna wire 15 (FIG. 3) by measuring the loop current. The display portion 14 visually displays the monitored intensity in suitable units, such as feet.

More specifically, the loop monitor 12 measures current flow through the antenna wire 15 and is operative to denote deterioration or a partial break of the antenna wire 15, to predict or indicate, respectively, a potential or an actual failure condition, i.e., an open circuit. More particularly, for a given voltage potential, more current will flow through an undamaged antenna wire 15, having minimal impedance, than will flow through a deteriorated or partially broken antenna wire 15 that has a greater impedance. Hence, the magnitude of current flowing through the antenna wire 15 provides indicia of the condition and integrity of the antenna wire 15. Because the intensity of the electromagnetic field about the antenna wire 15 is proportional to the magnitude of current flowing through an antenna wire 15 and, moreover, because the intensity of the electromagnetic field varies linearly with distance from the source, the magnitude of the current can be related to distance from the source for display purposes.

For example, in operation, a decrease in the intensity of the electromagnetic signal can denote a loop problem, such as a corroding wire splice in the buried antenna wire 15. The indication of a loop problem is provided long before an open circuit condition in the antenna wire 15, such as by a wire break, develops. A troublesome or problematic antenna wire 15 loop can thus be identified and serviced before a wire break.

In the event of an open loop condition, the loop alarm will sound. Thus, the loop monitor provides a warning long before a failure condition.

Although the monitoring and displaying device 10 can be a stand-alone device that is electrically- and operatively coupled to a transmitter, the transmitter may, instead, be structured and arranged to include the monitoring and displaying device. A block diagram of a transmitter 20 having a monitoring and displaying device 10 is shown in FIG. 1. In addition to the monitoring and displaying device 10, the transmitter 20 further includes a signal source 22, a current driver and loop detector 24, and a power amplifier 26.

The signal source 22 is electrically-coupled to the current driver and loop detector 24, which is electrically-coupled to the power amplifier 26. The power amplifier 26 includes a plurality of output terminals 25 and 27 that are electrically-coupled to the antenna wire 15. As previously described, the antenna wire 15 can be buried in a predetermined arrangement, such as around the perimeter of a yard or other area in which a dog is to be contained or from which a dog is to be restrained from entry.

The input of the loop monitoring portion 12 of the device 10 is electrically-coupled to the power amplifier 26 and the output of the loop monitoring portion 12 of the device 10 is electrically-coupled to the display portion 13. The loop monitoring portion 12 includes a low pass filter 11 and a peak detector 13.

In operation, the signal source 22 provides a continuous signal to the current driver and loop detector 24, which, in turn, uses the signal to drive a power amplifier 26. Monitor circuitry (not shown) disposed in the power amplifier 26 (or, alternatively, disposed in the loop monitoring portion 12 of the monitoring and display device 10) monitor the magnitude of the current flowing through the power amplifier 26 to the antenna wire 15 and provide these data to the loop monitoring portion 12.

The loop monitoring portion 12 processes these data, e.g., by filtering the data, first, through a Low-pass filter 11 to remove high frequency noise and harmonics. The filtered data are, then, passed through a peak detection device 13. The peak detection device 13 provides an output signal to the displaying portion 14, which provides a visual indication of the electromagnetic field intensity associated with the loop current magnitude.

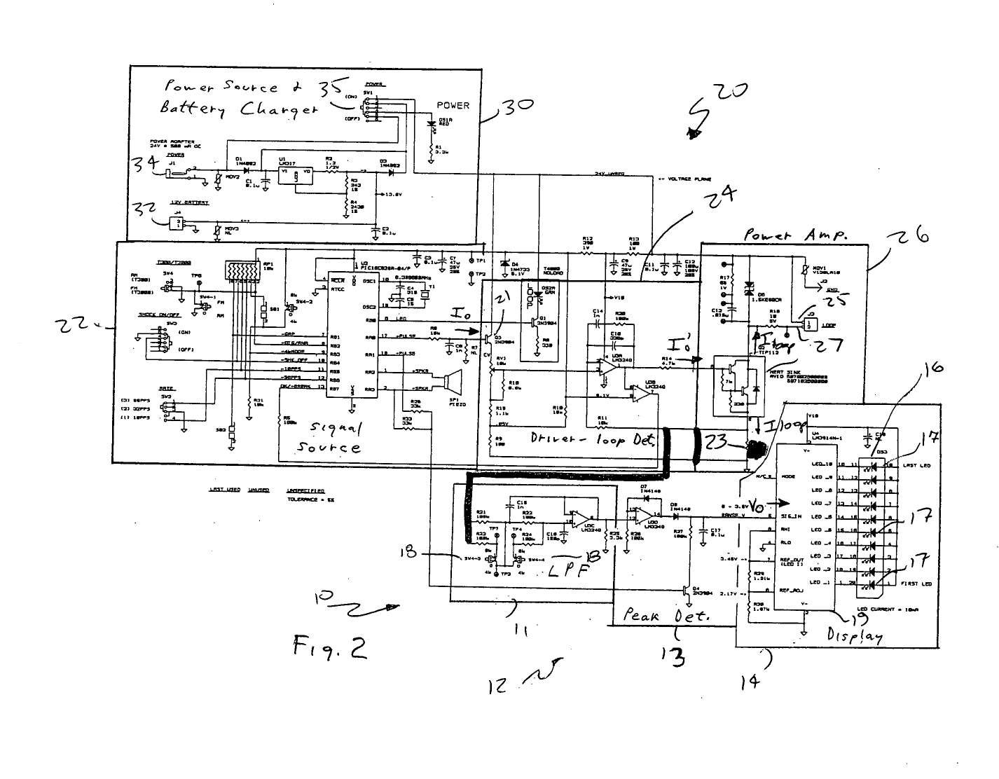

An illustrative circuit diagram of a transmitter 20 for a pet containment system, including a monitoring and displaying device 10, is shown in FIG. 2. The transmitter 20 and all portions thereof are energized by a power source 30. The power source 30 is structured and arranged to provide power to the transmitter 20 using a DC battery, such as a 12-volt battery, via a jack 32, and/or using a power adapter, such as a 24-volt, 500 mA power adapter, via a jack 34, that is capable of connection to a standard 110-volt power outlet.

The power source 30 includes a manual operating switch 35 for changing the state of the transmitter 20 from ON to OFF and vice versa. When the switch 35 is ON, the emitter (or gate) of a switching device 21, e.g., an impedance-changing switching device Q3, is appropriately driven so that current at the collector (or source electrode) of the switching device 21 flows to the base(or drain electrode) of the switching device 21.

The signal source 22 of the transmitter 20 produces output signals, Iₒ, that are input into the current driver and loop detector 24. More specifically, the output signals, Iₒ, are input into the current driver and loop detector 24 via the switching device 21, e.g., typically an npn bi-polar junction transistor or an n-type field effect transistor. When the emitter (or gate) of the switching device 21 is closed (with power switch 35 is ON), current from the signal source 22 flows into the current driver and loop detector 24. This occurs on every positive half-cycle of the signal current waveform. When the output signal drops to near zero, the switching device 21 stops conducting, and no current from the signal source 22 flows into the current drive and loop detector 24.

Those skilled in the art can appreciate that the same principle can occur be using a different configuration using other transistor types. Whether the emitter (or gate) of switching device 21 is open or closed depends on whether the voltage at the emitter (or gate) is driven HI or driven LO and on whether the switching device 21 is an n-type or p-type switching device.

The signal, Iₒ, from the signal source 22 passes through the current driver and loop detector 24 and is output (I′ₒ) to the power amplifier 26, where the current (I′ₒ) is amplified to a desired, pre-determined, changeable magnitude. Referring to FIG. 3, the amplified current is output to the antenna wire 15 as loop current, Iₗₒₒₚ. The loop current, Iₗₒₒₚ, induces the electromagnetic field 40. Current also flows through a resistive element 23 (R19 in FIG. 2) having a pre-determined resistance. Thus, the voltage across the resistive element (R19) 23 is representative of the loop current, Iₗₒₒₚ.

The voltage representative of the loop current is processed for driving the loop monitor display 14. More specifically, a Low-pass filter 11 filters out unwanted higher frequency signals and noise. The Low-pass filter 11 can also include one or more manually-operable switches (SW 4-3 and SW 4-4) 18, to accommodate different operating frequencies of the transmitter 20. The Low-pass filter 11 then provides the filtered signal to the peak detector 13.

The peak detector 13 provides the filtered signal to a converter, e.g., a converter on an integrated circuit chip. The converter converts the filtered signal to an analog output voltage, Vₒ. The magnitude of the analog output voltage, Vₒ, drives the display portion 14.

For example, as shown in FIG. 2, the output voltage, Vₒ, is input into an integrated circuit device 19, such as an LM3914, which drives a linear analog display 16, digital/analog meter or any other form of visual indicator. The linear analog display 16 can be a bar type or dot-type display. The linear analog display 16 of the display portion 14 includes a plurality, e.g., ten (10), light emitting diodes (LEDs) 17 (or similar light-emitting devices such as liquid crystal display devices (LCDs), vacuum fluorescent devices, and the like). The peak detector 13 and the LED driver device 19 are structured and arranged so that more of the LEDs 17 are illuminated when the output voltage, Vₒ, and loop current, Iₗₒₒₚ, are relatively high and so that fewer of the LEDs 17 are illuminated when the output voltage, Vₒ, and loop current, Iₗₒₒₚ, are relatively low, or one LED 17 can be lit at a time, corresponding to the amount of the loop current, Iₗₒₒₚ.

Thus, the display portion 14 of the transmitter system 20 provides a continuous, visible indication of the strength of the electromagnetic field radiated by the antenna wire 15 and, furthermore, provides real-time signal strength or range indication, by continuous monitoring of the current in the antenna wire 15.

In a typical implementation, the loop current indication is accurate to within about five percent (5%) of the actual electromagnetic field strength 40. The loop monitor 12 is typically calibrated in the transmitter 20 for receivers that placed about two (2) feet off the ground surface 45. For smaller and larger pets, the monitor can be recalibrated or a correction factor can be applied to account for the particular height of the receiver from the ground surface on a particularly sized dog.

The loop monitor 12 is accurate for traditional boundary wire configurations, which provide an antenna wire loop about a yard or around a garden or other area. For loop configurations that are non-traditional, such as where the loop is in a narrow banana or boomerang shape, the correction range is dependent on loop spacing as well as the magnitude of the current signal provided to the loop. In such instances the indicated loop range will usually have to be corrected according to a correction table provided for the particular non-traditional loop configuration.

To establish a correction zone, the range control on the transmitter 20 can be set to an intended correction range and the loop monitor display 14 is observed to indicate the actual range setting provided by the loop antenna 15. The range control can be adjusted to produce the actual intended range as denoted by the loop display.

While the invention is described through the above-described exemplary embodiments, it will be understood by those of ordinary skill in the art that modifications to, and variations of, the illustrated embodiments may be made without departing from the inventive concepts disclosed herein. Accordingly, the invention should not be viewed as limited, except by the scope and spirit of the appended claims.

What is claimed is:

1. A device for continuously monitoring the integrity of an antenna wire used in conjunction with a pet containment system, the device comprising:
a current monitoring portion for monitoring the magnitude of a current applied to the antenna wire to generate an electromagnetic field of a desired intensity about said antenna wire; and
a display portion for displaying a visual signal corresponding to the intensity of the electromagnetic field.

2. The device as recited in claim 1, wherein the current monitoring portion includes a filter and a voltage peak detector.

3. The device as recited in claim 2, wherein the filter is a Low-pass filter for filtering higher frequency components.

4. The device as recited in claim 2, wherein the voltage peak detector converts a filtered signal from the filter to an analog voltage output.

5. The device as recited in claim 4, wherein the analog voltage output drives the display portion.

6. The device as recited in claim 1, wherein the display portion includes a linear analog display and a display driver device.

7. The device as recited in claim 6, wherein the linear analog display is a bar-type or dot-type display comprising a plurality of light-emitting devices.

8. The device as recited in claim 7, wherein the display driver device illuminates more of the plurality of light-emitting devices when the intensity of the electromagnetic field is relatively high and illuminates fewer of the plurality of light-emitting devices when the intensity of the electromagnetic field is relatively low.

9. The device as recited in claim 7, wherein the display driver device illuminates each of the plurality of light-emitting devices one at a time as the intensity of the electromagnetic field increases.

10. A transmitter for monitoring the integrity of an antenna wire for a pet containment system, the transmitter comprising:
a signal source for generating continuous electrical signals;
a current driver and loop detector for driving the continuous electrical signals on an antenna wire of the containment system;
a power amplifier for amplifying the continuous electrical signals before said electrical signals are applied to the antenna wire;
a device for continuously monitoring the integrity of the antenna wire, the device including:
a current monitoring portion for monitoring the magnitude of a current applied to the antenna wire to generate an electromagnetic field of a desired intensity about said antenna wire; and
a display portion for displaying a visual signal corresponding to the intensity of the electromagnetic field.

11. The device as recited in claim 10, wherein the current monitoring portion includes a filter and a voltage peak detector.

12. The device as recited in claim 11, wherein the filter is a Low-pass filter for filtering higher frequency components.

13. The device as recited in claim 11, wherein the voltage peak detector converts a filtered signal from the filter to an analog voltage output.

14. The device as recited in claim 13, wherein the analog voltage output drives the display portion.

15. The device as recited in claim 10, wherein the display portion includes a linear analog display and a display driver device.

16. The device as recited in claim 15, wherein the linear analog display is a bar-type or dot-type display comprising a plurality of light-emitting devices.

17. The device as recited in claim 16, wherein the display driver device illuminates more of the plurality of light-emitting devices when the intensity of the electromagnetic field is relatively high and illuminates fewer of the plurality of light-emitting devices when the intensity of the electromagnetic field is relatively low.

18. The device as recited in claim 16, wherein the display device illuminates each of the plurality of light-emitting devices one at a time as the intensity of the electromagnetic field increases.

19. A pet containment system comprising:
a buried antenna wire for radiating an electromagnetic field as electrical current passes through the antenna wire;
a transmitter having a device for continuously monitoring the integrity of the antenna wire for predicting problems therewith, the device including:
a current monitoring portion for monitoring the magnitude of the electrical current applied to the antenna wire to generate an electromagnetic field of a desired intensity about said antenna wire, and
a display portion for displaying a visual signal corresponding to the intensity of the electromagnetic field; and
a receiver for providing an audible alert when the electromagnetic field exceeds a first pre-determined intensity level or an electrical stimulation when the electromagnetic field exceeds a second pre-determined intensity level.

20. The pet containment system as recited in claim 19, wherein the transmitter further includes:
a signal source for generating continuous electrical signals;
a current driver and loop detector for driving the continuous electrical signals on the antenna wire; and
a power amplifier for amplifying the continuous electrical signals before said electrical signals are applied to the antenna wire.

21. The pet containment system as recited in claim 19, the system further comprising a power source for providing the electrical current.
